(19) United States
(12) Patent Application Publication
(10) Pub. No.: US 2016/0017938 A1
(43) Pub. Date: Jan. 21, 2016

(54) CLUTCH ARRANGEMENT FOR A VEHICLE AND METHOD FOR OPERATING A VEHICLE

(71) Applicant: SCHAEFFLER TECHNOLOGIES AG & CO. KG, Herzogenaurach (DE)

(72) Inventors: Thomas Mehlis, Kleinsendelbach (DE); Andreas Kinigadner, Erlangen (DE)

(73) Assignee: SCHAEFFLER TECHNOLOGIES AG & CO. KG, Herzogenaurach (DE)

(21) Appl. No.: 14/771,926

(22) PCT Filed: Jan. 21, 2014
(86) PCT No.: PCT/DE2014/200018

§ 371 Date: Sep. 1, 2015

(30) Foreign Application Priority Data
Mar. 14, 2013 (DE) 10 2013 204 446.1

(51) Int. Cl. F16D 43/06

(52) U.S. Cl. CPC F16D 43/06

(57) ABSTRACT

A clutch arrangement for a vehicle for the purpose of detachably connecting two shafts (1, 2), characterized in that at least one shift sleeve (3) arranged in coaxially displaceable fashion on a shaft (1, 2) can, under centrifugal force actuation as a function of the increase in the rotational speed of a shaft (1, 2), be displaced from a position in which it provides rotationally locked coupling for the purpose of connecting the shafts (1, 2) into a position in which it decouples the shafts (1, 2). The invention also relates to a method for operating a vehicle.

### FIELD OF THE INVENTION

### Background

The invention relates to a clutch arrangement for a vehicle and a method for operating a vehicle.

Such a clutch arrangement is known from DE 199 14 350 B4. That publication describes a method for operating a motor vehicle with an internal combustion engine and at least one electric motor. The electric motor can be engaged with a wheel hub of the vehicle shaft as a function of its rotational speed via an automatically closing, non-positive fit, centrifugal force clutch. A non-positive fit to the centrifugal force clutch exists only when the electric motor is activated and the electric motor is rotating at high rotational speeds, while the centrifugal force clutch is open when the electric motor is deactivated or is rotating at low rotational speeds. The non-positive actuation of the clutch leads to friction losses due to clutch slip.

DE 198 09 302 A1 shows a centrifugal force clutch for small motors with an adjustment device that is actuated by centrifugal force and rotates with the motor shaft and is arranged on the free end of a follower sleeve mounted on the motor shaft. The adjustment device displaces a driven element mounted on the follower sleeve above a certain rotational speed axially from a position where it can rotate freely on the follower sleeve to a position in which a positive and/or non-positive fit exists between the driven element and follower sleeve. The formation of the adjustment devices on the follower sleeve is structurally complicated and also requires axial installation space on the free end of the follower sleeve.

### SUMMARY

Therefore, one objective of the invention is to provide a clutch arrangement of the type named above that prevents friction losses during operation and is easy to construct. Another objective is to provide a method for operating a vehicle with such a clutch arrangement.

The objective is achieved by one or more features of the invention.

A clutch arrangement for the detachable connection of two shafts is provided in which at least one shift sleeve that can move coaxially on one of the shafts can be moved by centrifugal force actuation as a function of the increase in rotational speed of a shaft out of an engaged position locking the shafts in rotation into a position decoupling the shafts. Therefore, above a predetermined rotational speed, the shafts can be decoupled from each other without torque using centrifugal force actuation. In addition, through the shift sleeve, a positive-fit coupling of the shafts is enabled, wherein friction losses can be avoided by a non-positive coupling of the shafts.

Advantageously, for the centrifugal force actuation of the shift sleeve, one or more centrifugal force weights locked in rotation with one of the shafts are provided for generating a centrifugal force. The centrifugal force weights engage followers for centrifugal force actuation in the shift sleeve. In this way, an easily constructed, installation space-saving, centrifugal-force actuated clutch arrangement is achieved, through which two shafts can be automatically coupled with each other as a function of rotational speed.

In one especially preferred construction of the invention, the shift sleeve is arranged so that it can move coaxially on an end area of a first shaft and here encloses at least partially a coaxially arranged end area of a second shaft so that it can move relative to this shaft. Advantageously, one or more centrifugal force weights are locked in rotation with the end area of the second shaft. In this way, the clutch arrangement can be switched as a function of the rotational speed of the second shaft, actuated by centrifugal force. For the centrifugal force actuation, one or more centrifugal force weights engage the followers in the end section of the shift sleeve facing the end area of the second shaft.

In another especially preferred construction, the first shaft is formed by an engine shaft of an electric motor and the second shaft is formed by a transmission shaft of a vehicle transmission. Here, for example, in hybrid vehicles, an electric motor integrated in the conventional drive train can be coupled with a positive fit on its engine shaft via the clutch arrangement according to the invention with the transmission shaft, especially transmission output shaft, and can be automatically decoupled from this as a function of the rotational speed of the transmission shaft by centrifugal force. In this way, slip losses at higher rotational speeds of the transmission shaft or at higher vehicle speeds can be minimized by decoupling the electric motor from the drive train. Because the clutch arrangement according to the invention automatically opens as a function of rotational speed, actuated by centrifugal force, an additional actuator and a corresponding control are omitted.

In another especially preferred construction of the invention, the shift sleeve is arranged so that it can move on its inner diameter on a first shaft between a position locked in rotation with a positive fit with this shaft and a position where it can rotate freely on this shaft and is locked in rotation with a second shaft on its outer diameter.

For the rotationally locked connection of the shift sleeve to the second shaft, a coaxially arranged clutch arrangement can be provided. Advantageously, the shift sleeve is locked in rotation via a clutch housing to the second shaft. Preferably, the clutch housing has a hub-shaped end section that at least partially coaxially encloses the shift sleeve and is locked in rotation with this sleeve with a positive fit and can be moved axially. In this way, the shift sleeve is guided axially for a displacement on its outer diameter on the clutch housing. In the position of the shift sleeve coupled with the first shaft, a drive power or a torque can be transferred between the first and second shafts via this sleeve and the clutch housing.

Here, for example, on the inner lateral surface of the hub-shaped section of the clutch element, there are radial projections that are locked in rotation on the outer diameter of the shift sleeve in corresponding axial, longitudinal recesses and engage so that it can move longitudinally. For example, an interference fit or plug-in tooth engagement can be provided, in particular, with wedge-shaped or spline-shaped teeth.

For the positive fit coupling with the first shaft, on the inner diameter of the shift sleeve there are advantageously several projections extending radially inward with a tab-like shape in the circumferential direction one after the other. In the position of the shift sleeve coupled with the first shaft, these engage rotationally locked in opposite, corresponding longitudinal recesses on the outer diameter of the first shaft and can move axially. Advantageously, the recesses are limited in the axial direction by an annular groove that surrounds the outer diameter of the first shaft and in which the projections can engage in the position of the shift sleeve where it can rotate freely on the first shaft.

Preferably, the followers of the centrifugal force weights and the shift sleeve are in areal contact on corresponding inclined surfaces for transmitting an axial adjustment force to the shift sleeve.

It is an advantage when each follower is constructed as an axial projection on the centrifugal force weight tapering toward its free end for engaging in an end section of the shift sleeve.

The inclined surfaces can each be formed by a bevel on the followers and shift sleeve.

Preferably, the inclined surfaces are constructed as conically shaped contact surfaces on the followers and shift sleeve and form a conical connection.

Advantageously, several centrifugal force weights that can move orthogonally at the end area of the first shaft and are arranged one behind the other in the circumferential direction are integrated in a pot-shaped housing section of the clutch element arranged coaxial to the end area of the second shaft. Thus, in a simple way, the centrifugal force weights can be arranged compactly, in rotationally locked connection with the second shaft, guided with centrifugal force actuation. Preferably, the centrifugal force weights are arranged in a uniform distribution in the circumferential direction.

A simple fastening of the clutch housing is achieved if this has a flange-like end section that is formed coaxial to the second shaft and encloses the end area of the second shaft at least in some sections and is connected locked in rotation and axially fixed with this shaft. For this purpose, for example, an interference fit can be provided. Positive-fit connections are also conceivable.

For restoring a centrifugal force actuated displacement of the shift sleeve, a restoring device is provided. This advantageously has restoring spring means arranged coaxial to the first shaft. Preferably, these tension the shift sleeve against the followers of the centrifugal force weights. In this way it is guaranteed that the shift sleeve and followers are in constant areal contact on the inclined surfaces. One or more compressive springs or tensile springs can be provided as the restoring spring means. The restoring spring means can have at least one helical spring surrounding coaxially the first shaft in some sections. These can be supported axially on a spring end on one end of the shift sleeve and on the other spring end on the first shaft, for example, on an axial securing element connected to this shaft or on a shaft projection. Alternatively, one or more installation space-saving plate springs can be provided as restoring spring means. Advantageously, the restoring spring means are supported on the shift sleeve by means of an axial support, in order to optionally compensate for rotational speed differences between this sleeve and the restoring spring means, especially when the shift sleeve is located in the position where it can rotate freely on the first shaft.

According to another aspect of the invention, a method for operating a vehicle with a clutch arrangement for detachable connection of two shafts is provided. Here, the clutch arrangement is moved from a state rotationally locking the shafts with a positive fit as a function of the increase of the rotational speed of a shaft at a predetermined rotational speed through centrifugal force actuation into a state decoupling the shafts from each other. In this way it is possible to keep the clutch arrangement closed when the vehicle is at a standstill or at lower rotational speeds and to open the clutch arrangement with centrifugal force actuation at higher rotational speeds.

In this way, for example, the engine shaft of an electric motor can be decoupled with centrifugal force actuation from a transmission shaft of a vehicle transmission as a function of the rotational speed of the transmission shaft at high transmission shaft rotational speeds or at high vehicle speeds. In a state decoupled from the transmission shaft, an auxiliary engine drive can be driven or continued by the electric motor, in particular, at high vehicle speeds, independent of the rotational speed of the transmission shaft or the vehicle speed.

For closing the clutch arrangement, it is advantageous if the rotational speeds of the shafts are synchronized for preventing friction losses in a positive-fit coupling of the shafts. For example, for the positive-fit coupling of the engine shaft of the electric motor to the transmission shaft, the rotational speeds of the engine shaft and the transmission shaft can be synchronized by the electric motor. The synchronization can be performed by means of the electronic rotational speed control of the electric motor.

### BRIEF DESCRIPTION OF THE DRAWINGS

Additional features of the invention are given from the following description and from the drawings, in which an embodiment of the invention is shown in simplified form. Shown are:

FIG. 1 a perspective diagram of a clutch arrangement according to the invention,

FIG. 2 a longitudinal section of the clutch arrangement from FIG. 1 in a first operating state,

FIG. 3 an enlarged section from FIG. 2,

FIG. 4 a cross section of the clutch arrangement along the line A-A in FIG. 3,

FIG. 5 a partial longitudinal section of the clutch arrangement in a second operating state,

FIG. 6 a partial longitudinal section of the clutch arrangement in a third operating state.

### DETAILED DESCRIPTION OF THE PREFERRED EMBODIMENTS

FIGS. 1 to 4 show an example construction of a clutch arrangement according to the invention for a vehicle for the detachable connection of two shafts. A first and a second shaft 1, 2 are arranged coaxially opposite each other at their end areas. The first shaft 1 is here formed as an example by the engine shaft of a not shown electric motor and the second shaft 2 by a transmission shaft, in particular, a transmission output shaft, of a not shown vehicle transmission.

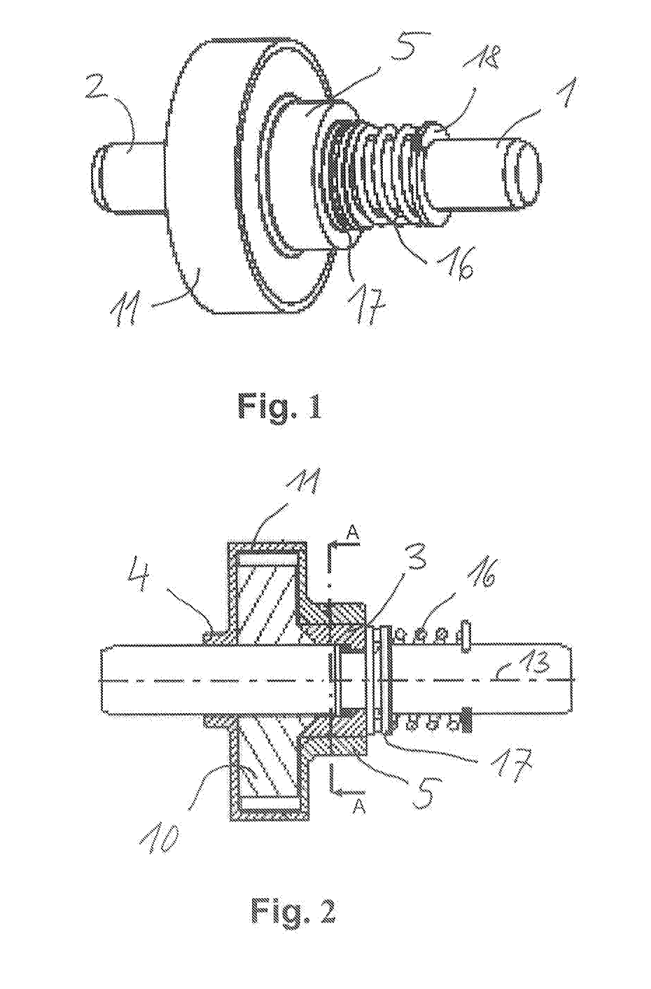

The clutch arrangement has a shift sleeve 3 that is arranged so that it can move coaxially on the end area of the first shaft 1 and encloses the end area of the second shaft 2 so that it can move coaxially to this shaft on a section. Here, the shift sleeve 3 is constructed so that it can be locked in rotation with a positive fit on its inner diameter with the first shaft land connected to the second shaft 2 so that it can move locked in rotation with a positive fit via a clutch housing simultaneously on its outer diameter. The clutch housing encloses the end areas of the shafts 1, 2 coaxially. On its axial side facing the second shaft 2, the clutch housing forms an end section 4 constructed for connecting as a ring flange and on which the clutch housing is pressed on the end area of the second shaft 2 in an interference fit rotationally locked and axially fixed (FIGS. 1 and 2). Positive fit or positive-fit/non-positive-fit or material-fit connections between the clutch housing and second shaft 2 are also conceivable.

On its axial side facing the first shaft 1, the clutch housing forms a hub-shaped end section 5 that coaxially surrounds the shift sleeve 3 on its outer diameter. Here, the shift sleeve 3 is locked in rotation on the hub-shaped end section 5 with the clutch housing with a positive fit and can be moved axially. For this purpose, radial projections 6 that engage locked in rotation and movable in the longitudinal direction on the outer diameter of the shift sleeve 3 in corresponding, axially extending, longitudinal recesses 7 or longitudinal grooves are formed on the inner lateral surface of the hub-shaped end section 5 (FIG. 4). The projections 6 and the recesses 7 each have a continuous axial construction, i.e., over the entire axial length of the hub-shaped end section 5 or shift sleeve 3. In this way, on the shift sleeve 3, over the entire axial length on its outer diameter, an axial guidance and a positive fit in the circumferential direction on the clutch housing can be achieved for transmitting a drive power. The recesses 7 and projections 6 are each arranged distributed uniformly over the circumference. They each have a rectangular cross sectional profile and form involute teeth between the clutch housing and shift sleeve 3.

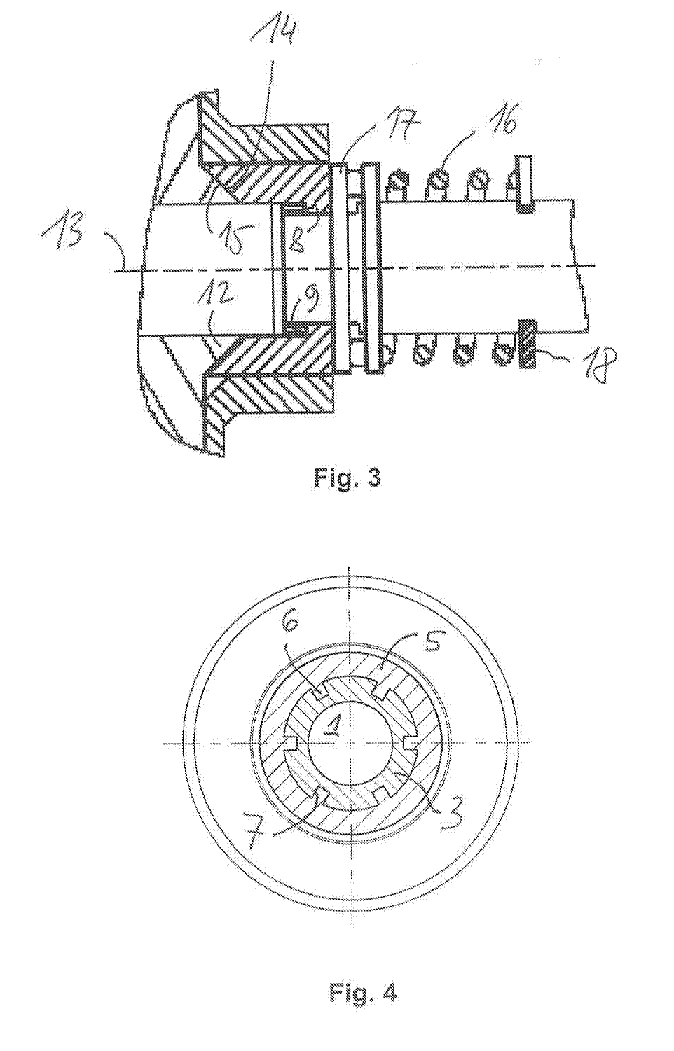

The illustrated first operating state shows the clutch arrangement in closed output state, i.e., coupling the shafts 1, 2. Here, a torque or a drive power can be transmitted between the first and second shafts 1, 2 via the shift sleeve 3 and the clutch housing. In the output state, the shift sleeve 3 is located on its inner diameter in a position locked in rotation with a positive fit with the first shaft 1. Here, the shift sleeve 3 forms on its end facing the end area of the first shaft 1 on the inner diameter several radially inward, tab-shaped, extending projections 8 one behind the other in the circumferential direction. These engage in opposing, corresponding longitudinal recesses 9 or longitudinal grooves rotationally locked and axially movable on the outer diameter of the end area of the first shaft 1 (FIG. 3). The recesses 9 extend starting from the end of the first shaft 1 in the axial direction. For an axial displacement from the starting position, the shift sleeve 3 is guided on its inner diameter on the projections 8 into the recesses 9 on the first shaft 1.

On its end facing the end area of the second shaft 2, the shift sleeve 3 is in active connection with several centrifugal force weights 10 that are rotationally locked and can move orthogonal to the end area of the second shaft. These weights are used for the centrifugal force actuation of the shift sleeve 3 as a function of the centrifugal force generated by the rotation of the second shaft 2 on the centrifugal force weights 10. The centrifugal force weights 10 are distributed uniformly over the circumference of the first shaft 1 and are integrated rotationally locked in a pot-shaped section 11 of the clutch housing and are arranged radially movable. The centrifugal force weights 10 are here guided on the axial inner walls of the clutch housing and by a not shown holding device in the circumferential direction. In the shown first operating state, the second shaft 2 does not rotate or has only a low rotational speed. Here, the centrifugal force weights 10 are each radially inside on the outer diameter of the second shaft 2. For this purpose, the radially inner end sides of the centrifugal force weights 10 are adapted to the outer diameter of the second shaft 2 with a shape curved concavely inward. The centrifugal force weights 10 are each block-shaped with narrow sides in the axial and radial directions and wide sides in the circumferential direction. The centrifugal force weights 10 have, on their narrow axial sides facing the first shaft 1, radially inner followers 12 for centrifugal force actuation of the shift sleeve 3. The followers 12 are each formed integrally with the centrifugal force weight 10 as an axial shoulder or projection. Here, the shift sleeve 3 is arranged on its end section coaxially surrounding the end area of the second shaft 2 radially spaced apart from the outer diameter of the second shaft 2 and thus forms a radial air gap to this shaft. In this gap, the followers 12 on the shoulders or projections engage. For this purpose, the followers 12 are arranged coaxial to the shift sleeve. The projections forming the followers 12 are tapered on their radially outer side toward their ends facing the first shaft 1. Here, they are in areal contact with the inner diameter of the shift sleeve 3 on corresponding inclined surfaces 14, 15 at an angle to the rotational axis 13. These are oriented such that, from the centrifugal force of the centrifugal force weights 10 transmitted to the followers 12 on the inclined surfaces 14, 15, an adjustment force acting in the axial direction facing away from the second shaft 2 is transmitted onto the shift sleeve 3. The shift sleeve 3 and followers 12 here form, on the inclined surfaces 14, 15, a cone connection with an inner cone on the inner diameter of the shift sleeve 3 and corresponding outwardly conical contact surfaces on the followers 12.

For restoring the shift sleeve 3, axial restoring spring means 16 are provided (FIGS. 1 to 3). During a centrifugal force actuated axial displacement of the shift sleeve 3 from the starting position, these spring means generate a restoring spring force acting against the displacement. Here, for example, a helical spring arranged coaxial to the first shaft 1 is provided as a compression spring for restoring the shift sleeve 3. This is supported with one spring end by means of an axial bearing 17 on the end of the shift sleeve 3 facing the end area of the first sleeve 1 and with the other spring end on an axial securing element 18, here a securing ring pressed onto the first shaft 1. The restoring spring 16 tensions the shift sleeve 3 against the followers 12 of the centrifugal force weights 10 in the axial direction. Therefore, a constant areal contact of the followers 12 and shift sleeve 3 is guaranteed on the inclined surfaces 14, 15 both for a centrifugal force actuated displacement for opening the clutch arrangement and also for a restoring of the shift sleeve 3 for closing the clutch arrangement through the restoring spring force generated by the restoring spring means 16.

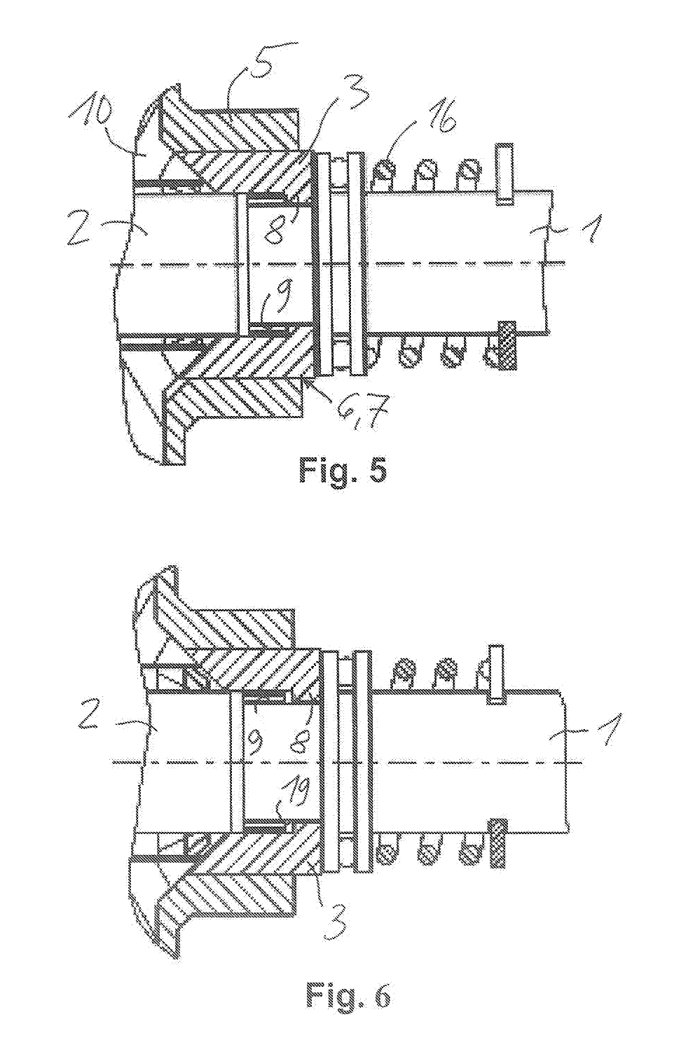

For the rotation of the second shaft 2, the co-rotating centrifugal force weights 10 are pressed radially outward by the centrifugal force, so that a radial air gap is produced between the radially inner end sides of the centrifugal force weights 10 and the outer diameter of the second shaft 2 (FIG. 5). Here, as a function of the centrifugal force generated by the rotational speed of the second shaft 2 on the centrifugal force weights 10 on the followers 12 on the inclined surfaces 14, 15, an axial adjusting force is transmitted onto the shift sleeve 3. In this way, this sleeve is displaced axially along the first shaft 1 against the restoring spring force of the restoring spring means 16 until force equilibrium is achieved between the axial adjusting force and restoring spring force on the shift sleeve 3. For an axial displacement of the shift sleeve 3, this is guided axially on the projections 8 on their inner diameter in the longitudinal grooves 9 on the outer diameter of the first shaft 1 and in the longitudinal grooves 7 on their outer diameter on the projections 6 on the inner diameter of the hub-shaped end section 5 of the clutch housing.

For further increase in the rotational speed of the second shaft 2, the shift sleeve 3 is displaced farther along the first shaft 1 in the direction away from its end or the second shaft 2 until the rotational speed of the second shaft 2 increases to a predetermined rotational speed and the end position of the shift sleeve 3 is reached (FIG. 6). Here, the tab-shaped projections 8 on the inner diameter of the shift sleeve 3 engage in a ring-shaped, surrounding recess 19 or annular groove axially limiting the longitudinal grooves 9 on the outer diameter of the first shaft 1. Therefore, the positive fit in the circumferential direction between the first shaft 1 and shift sleeve 3 is disengaged, wherein this is moved into a position where it can rotate freely on the first shaft 1. Therefore, the first and second shafts 1, 2 are decoupled and the clutch arrangement is located in an open state.

With decreasing rotational speed of the second shaft 2, the centrifugal force acting on the centrifugal force weights 10 and thus the axial adjusting force transmitted to the shift sleeve 3 are reduced. Until a force equilibrium is reached between this and the restoring spring force of the restoring spring means 16, the shift sleeve 3 is shifted back in the direction of the second shaft and therefore the clutch arrangement is transferred back into its closed state. Here, the projections 8 on the inner diameter of the shift sleeve are pressed by the restoring spring force of the restoring spring means 16 from the ring-shaped recess 19 on the outer diameter of the first shaft 1 back into the longitudinal grooves 9. Here, the closing of the clutch arrangement can be supported with control means by the electric motor driving the first shaft 1 as the engine shaft. For this purpose, the rotational speed of the engine shaft is adapted by the rotational speed control of the electric motor to the rotational speed of the second shaft 2 forming the transmission shaft. When the rotational speeds of the engine shaft and transmission shaft match, these are in a torque-free state relative to each other. Therefore, the projections 8 on the inner diameter of the shift sleeve 3 can be pressed out of the ring-shaped recess 19 on the outer diameter of the engine shaft free from forces and thus free from friction into the longitudinal grooves 9 by the restoring spring force.

### LIST OF REFERENCE NUMBERS

1 Shaft
2 Shaft
3 Shift sleeve
4 End section
5 End section
6 Projection
7 Recess
8 Projection
9 Recess
10 Centrifugal force weight
11 Section
12 Follower
13 Rotational axis
14 Inclined surface
15 Inclined surface
16 Restoring spring means
17 Axial bearing
18 Securing element
19 Recess

1. A clutch arrangement for a vehicle for detachable connection of two shafts, comprising at least one shift sleeve that can move coaxially on one of the shafts is movable by centrifugal force actuation as a function of an increase of a rotational speed of the shafts from a position locking the shafts in rotation into a position decoupling the shafts.

2. The clutch arrangement according to claim 1, wherein for the centrifugal force actuation of the shift sleeve, one or more centrifugal force weights locked in rotation with one of the shafts are provided for generating a centrifugal force and the one or more centrifugal force weights engage followers in the shift sleeve.

3. The clutch arrangement according to claim 1, wherein the shift sleeve is arranged to move coaxially on an end area of a first one of the shafts and at least partially encloses a coaxially arranged end area of second one of the shafts so that it can move coaxially relative to said second shaft and one or more centrifugal weights are locked in rotation with the end area of the second shaft and coaxially engage the followers for centrifugal force actuation in the end section of the shift sleeve enclosing an end area of the second shaft.

4. The clutch arrangement according to claim 1 wherein the first shaft is formed by an engine shaft of an electric motor and the second shaft is formed by a transmission shaft of a vehicle transmission.

5. The clutch arrangement according to claim 1, wherein the shift sleeve is arranged with an inner diameter thereof on a first one of the shafts for movement between a position forming a positive, rotationally locked fit with the first shaft and a position where it can rotate freely on the first shaft and is locked in rotation with the second shaft by an outer diameter of the shaft sleeve.

6. The clutch arrangement according to claim 3, wherein the shift sleeve is connected with a positive, rotationally locked fit on an outer diameter thereof with a hub-shaped end section of a clutch housing locked in rotation with the second shaft and is movably axially.

7. The clutch arrangement according to claim 6, wherein the shift sleeve has, on an inner diameter thereof, multiple projections that extend in a shape of tabs radially inward one behind the other in a circumferential direction and engage locked in rotation and axially displaceable in the position of the shift sleeve coupled with the first shaft in opposing, corresponding longitudinal recesses on an outer diameter of the first shaft, wherein said recesses are limited in the axial direction by an annular recess that surrounds the outer diameter of the first shaft and in which the projections can engage in a position of the shift sleeve where it can rotate freely on the first shaft.

8. The clutch arrangement according to claim 2, wherein the followers of the centrifugal force weights and the shift sleeve are in areal contact on corresponding inclined surfaces for transmitting an axial adjustment force.

9. The clutch arrangement according to claim 8, wherein several of the centrifugal force weights arranged to move orthogonal to an end area of the second shaft and one behind the other in a circumferential direction are integrated in a pot-shaped section of a clutch housing arranged coaxial to the end area of the second shaft.

10. The clutch arrangement according to claim 2, wherein for restoring a centrifugal force-actuated displacement of the shift sleeve, a restoring spring element is arranged coaxial to a first one of the shafts and the spring element axially pretensions the shift sleeve against the followers of the centrifugal force weights.

11. A method for operating a vehicle with a clutch arrangement for the detachable connection of two shafts, the clutch arrangement is transferred out of a state locking the shafts in rotation as a function of an increase of the rotational speed of the shafts at a predetermined rotational speed by centrifugal force actuation into a state decoupling the shafts.
